(19) United States
(12) Patent Application Publication
(10) Pub. No.: US 2016/0040807 A1
(43) Pub. Date: Feb. 11, 2016

(54) FLEXIBLE PIPELINE

(71) Applicant: NEXANS, Paris (FR)

(72) Inventors: Rainer Soika, Hannover (DE); Michele Di Palma, Springe (DE)

(21) Appl. No.: 14/797,463

(22) Filed: Jul. 13, 2015

(30) Foreign Application Priority Data
Aug. 8, 2014 (EP) 14 306 257.8

(51) Int. Cl. F16L 11/14; F16L 59/153

(52) U.S. Cl. CPC F16L 11/14; F16L 59/153

(57) ABSTRACT

A flexible pipeline to transport a frozen medium is provided where the pipeline has a central guide tube (1) of metal, undulated transversely of its longitudinal direction for conducting the frozen medium, and transversely of its longitudinal direction a limiting type tube (6) of metal. In the intermediate space (7) between the guide tube (1) and the limiting type pipe (6), is a cooling space for conducting an outer frozen medium, and wherein the intermediate space (7) is evacuated. That over the entire length of the pipeline around the guide tube (1) is wound at least one undulated cooling pipe (4) of metal which has a significantly smaller outer diameter than the guide tube (1) and forms a cooling space for conducting the outer frozen medium therethrough. That circumferentially over the entire length around the unit of the guide tube (1) and the cooling tube (4), a layer (5) is applied which serves as a super insulation and has at least one layer of reflecting foil.

### RELATED APPLICATION

This application claims the benefit of priority of European Patent Application No. 14 306 257.8, filed on Aug. 8, 2015, the entirety of which is incorporated by reference.

### BACKGROUND

1. Field of the Invention

The invention relates to a flexible pipeline for transporting a frozen medium, wherein the pipeline has a central guide tube of metal, undulated transversely of its longitudinal direction for conducting the frozen medium, and a limiting type tube of metal. In the intermediate space between the guide tube and the limiting type, a cooling space for conducting an outer frozen medium, and wherein the intermediate space is evacuated (EP 2 253 878 B1).

2. Description of Related Art

Such a pipeline is used, for example, for supplying superconductive magnetic systems or cryopumps or cooling plants with a required cooling medium. It should be flexible and have a substantial length. The tubes which are used may advantageously of high grade steel. They are undulated transversely of their longitudinal direction and, therefore, not only easily bendable, but also stable relative to radial loads. The undulation extending transversely of its longitudinal direction may be constructed helically or also ring shaped.

In the known pipeline according to the aforementioned EP 2 253 878 B1, between the guide tube and the limiting pipe is arranged a second pipe system to act as a thermal screen while conducting the frozen medium through the guide tube. The second pipe system consists of an interior pipe of metal undulated transversely of its longitudinal direction, and an outer undulated pipe of metal transversely of its longitudinal direction at a distance coaxially to the same. The inner pipe of the second pipe system is arranged spatially close to the guide tube of the pipeline and, between the guide tube of the pipeline and the inner pipe of the second pipe system is arranged the guide tube of the inner pipe immovably in its relative position to the pipeline. This known pipeline has been found useful in practice. However, because of the presence of four pipes arranged concentrically and at a distance from each other, it requires a relatively large outer diameter.

3. Objects and Summary

The invention is based on the object to further develop the initially described pipeline in such a way that its outer diameter can be reduced as compared to the pipeline disclosed, for example, in EP 2 253 878 B1.

In accordance with the invention, this object is met thereby,
that over the entire length of the pipeline is helically wound at least one cooling pipe of metal which has a significantly smaller outer diameter than the guide tube and forms a cooling space for conducting the outer frozen medium therethrough, and
that circumferentially over the entire length around the unit of the guide tube and the cooling tube, a layer is applied which serves as a super insulation consists of at least one layer of reflecting foil.

The size of the cooling space through which the outer frozen medium is conducted is determined by the outer diameter of the at least one cooling tube. This outer diameter is significantly smaller than the outer diameter of the guide tube, so that radial dimensions of the unit of the guide tube and the cooling pipe compared to the dimensions of the known pipeline according to EP 2 253 878 E1, up to the pipe of the second system, are significantly smaller. Consequently, this is also true for the total pipeline to which, in addition to the unit of the guide tube and the cooling pipe, the layer of super insulation and the outer limiting pipe belong, which in its totality surrounds the an evacuated intermediate space in which the intermediate space is also located. In practical use the pipeline has a 25% to 30% smaller outer diameter as compared to the known pipeline, in accordance with the mentioned document, thereby significantly facilitating the manipulation of the pipeline.

In accordance with a preferred embodiment, a plurality of cooling pipes is wound around the central guide tube with correspondingly increased cooling space, wherein the cooling pipes can also be placed one tightly against the other.

### BRIEF DESCRIPTION OF THE DRAWINGS

An embodiment of the subject matter of the invention is illustrated in the drawings.

In the drawing:

FIG. 1 is a cross sectional view through a pipeline according to the invention.

FIG. 2 shows a detail of the pipeline according to FIG. 1 in a purely schematic illustration.

### DETAILED DESCRIPTION

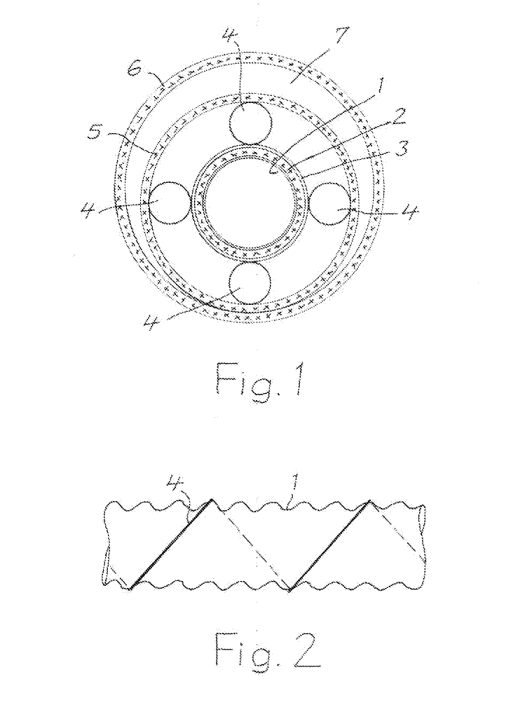

The guide tube 1, illustrated in FIG. 1, serves to guide a frozen medium, for example, a liquid helium which can be fed at a temperature of 4.5K into the guide tube 1. The guide tube 1 is undulated transversely of its longitudinal direction and becomes bendable, but also stable against radial loads. Advantageously it consists of high grade steel. A layer 2 of a thermally insulating material is mounted around the guide tube 1, as illustrated in the embodiment in accordance with FIG. 1, which is advantageously surrounded by a layer 3 composed of mechanically stable material. However, it advantageously be constructed as a super insulation and have one layer of a plastic band which is at least on one side coated with metal.

In the illustrated embodiment, arranged around the guide tube 1, or the layers 2 and 3 surrounding the guide tube 1, are four cooling pipes 4 which are wound helically over the entire length of the guide tube 1. There must be at least one cooling pipe 4 helically wound around the guide tube 1, illustrated in the purely schematic embodiment in FIG. 2. The cooling pipe is represented just by a line. There can be two or three or as many as four cooling pipes 4 wound around the guide tube 1.

The cooling pipes 4 serve to guide an outer frozen medium. Consequently, they create, in their totality, a thermal shield against the outside warming of the frozen medium conducted in the guide tube 1. For example, liquid nitrogen at a temperature of about 80K can be fed into the cooling pipes 4. A gaseous helium may be used instead of the liquid nitrogen, which preferably is fed into the cooling pipe 4 at the far end of the pipeline.

The outer diameter of the cooling pipes 4 is significantly smaller than the outer diameter of the guide tube 1. Advantageously, it is about 30% from the outer diameter of the guide tube 1. Preferably 30% of the outer diameter of the guide pipe 1 is 30% less than the outer diameter of the cooling pipes 4. Preferably the outer diameter of the cooling pipes 4 is significantly less than 30% of the outer diameter of the guide tube 1. For example, it can also be only 10% from the outer diameter of the guide tube 1. These measurements also apply analogously to each inner diameter of the pipes.

Preferably the cooling pipes are composed of metal. They are also advantageously undulated transversely of their longitudinal direction and are therefore easily bendable.

Around the cooling pipes 4 of the unit of the guide tube 1 and the cooling tube 4, a layer 5 is applied which serves as a super insulation. The layer 5 consists of at least one layer of reflecting foil and has one layer of a plastic band which is at least on one side coated with metal. The reflecting foil can also be a metal foil. Eventually the outer penetrating warmth would be repelled e.g., reflected.

In addition the pipeline has a limiting type tube 6 of metal undulated transversely of its longitudinal direction and is composed, advantageously, of high grade steel. It is arranged at a distance from layer 5 and surrounds an intermediate space 7 not only outside the layer 5, but also available inside the same wherein the intermediate space is evacuated. The cooling pipes 4 are thus located in a vacuum, in the evacuated intermediate space 7.

1. A flexible pipeline for transporting a frozen medium, comprising:
a central guide tube of metal, undulated transversely of its longitudinal direction for conducting the frozen medium, and a limiting type tube of metal,
in the intermediate space between the guide tube and the limiting type tube is located a cooling space for conducting an outer frozen medium, and
the intermediate space is evacuated,
wherein, over the entire length of the pipeline around the guide tube, is wound at least one undulated cooling pipe of metal which has a significantly smaller outer diameter than the guide tube and forms a cooling space for conducting the outer frozen medium therethrough, and
wherein circumferentially over the entire length around the unit of the guide tube and the cooling tube, a layer is applied which serves as a super insulation and has at least one layer of reflecting foil.

2. Pipeline according to claim 1, wherein the outer diameter of the cooling pipes is 30% or less in size than the outer diameter of the guide tube.

3. Pipeline according to claim 1, wherein at least one layer of thermally insulating material surrounds the guide tube.

4. Pipeline according to claim 1, wherein a plurality of cooling pipes packed tightly one against the other is wound around the central guide tube.

5. Pipeline according to claim 1, wherein the reflecting foil is a plastic band with at least one side coated in metal.

6. Pipeline according to claim 1, wherein the reflecting foil is a metal foil.
